(19) United States
(12) Patent Application Publication
(10) Pub. No.: US 2013/0336386 A1
(43) Pub. Date: Dec. 19, 2013

(54) SAMPLE ADAPTIVE OFFSET (SAO) CODING

(71) Applicant: QUALCOMM Incorporated, San Diego, CA (US)

(72) Inventors: In Suk Chong, San Diego, CA (US); Joel Sole Rojals, La Jolla, CA (US); Marta Karczewicz, San Diego, CA (US)

(21) Appl. No.: 13/919,955

(22) Filed: Jun. 17, 2013

Related U.S. Application Data
(60) Provisional application No. 61/661,240, filed on Jun. 18, 2012.

(51) Int. Cl. H04N 7/26

(52) U.S. Cl. CPC H04N 19/00066
USPC 375/240.02

(57) ABSTRACT

A video coder according to the techniques of the present disclosure may code a prefix value and code a suffix value, such that the combination of the suffix value and the prefix value identify an offset value determined for a sample adaptive offset filtering (SAO) operation.

This application claims the benefit of U.S. Provisional Patent Application No. 61/661,240 filed 18 Jun. 2012, the entire content of which is incorporated by reference herein.

### TECHNICAL FIELD

This disclosure relates to video coding and, more particularly, to techniques for sample adaptive offset (SAO) offset coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure describes techniques related to sample adaptive offset (SAO) filtering, and more particularly, this disclosure describes techniques for signaling, in an encoded bitstream of video data, offset values that may be used in SAO filtering operations. According to the techniques of this disclosure, an offset value can be signaled using a prefix value and a suffix value, where the combination of the suffix value and the prefix value identify the offset value. The prefix value may, for example, be a truncated unary value, and the suffix value may be a fixed length codeword.

In one example, a method for decoding video data includes receiving a prefix value in a bitstream of encoded video data; receiving a suffix value in the bitstream of encoded video data; and, determining an offset value for a sample adaptive offset filtering (SAO) operation such that the combination of the suffix value and the prefix value identify the offset value.

In another example, a method for encoding video data includes determining an offset value for a sample adaptive offset filtering (SAO) operation; generating a prefix value; and, generating a suffix value, wherein the combination of the suffix value and the prefix value identify the offset value.

In another example, an apparatus for decoding video data includes a video decoder configured to receive a prefix value in a bitstream of encoded video data; receive a suffix value in the bitstream of encoded video data; and, determine an offset value for a sample adaptive offset filtering (SAO) operation; wherein the combination of the suffix value and the prefix value identify the offset value.

In another example, an apparatus for encoding video data includes a video encoder configured to determine an offset value for a sample adaptive offset filtering (SAO) operation; generate a prefix value; and, generate a suffix value, such that the combination of the suffix value and the prefix value identify the offset value.

In another example, an apparatus for coding video data includes means for determining an offset value for a sample adaptive offset filtering (SAO) operation; means for coding a prefix value; and, means for coding a suffix value, wherein the combination of the suffix value and the prefix value identify the offset value.

In another example, a computer readable storage medium stores instructions that when executed cause one or more processors to determine an offset value for a sample adaptive offset filtering (SAO) operation; code a prefix value; and, code a suffix value, wherein the combination of the suffix value and the prefix value identify the offset value.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIGS. 2A-D are conceptual diagrams illustrating example edge offset classifications for sample adaptive offset coding.

FIG. 3 is a conceptual diagram illustrating example band offset classifications for sample adaptive offset coding.

FIG. 4 is a block diagram illustrating an example video encoder that may implement the techniques described in this disclosure.

FIG. 5 is a block diagram illustrating an example video decoder that may implement the techniques described in this disclosure.

FIG. 6A is a block diagram illustrating an example entropy encoder that may implement the techniques described in this disclosure.

FIG. 6B is a block diagram illustrating an example entropy decoder that may implement the techniques described in this disclosure.

FIG. 7 is a flow diagram illustrating a method for encoding video data in accordance with the techniques of this disclosure.

FIG. 8 is a flow diagram illustrating a method for decoding video data in accordance with the techniques of this disclosure.

### DETAILED DESCRIPTION

This disclosure describes techniques related to sample adaptive offset (SAO) filtering, and more particularly, this disclosure describes techniques for signaling, in an encoded bitstream of video data, offset values that may be used in SAO filtering operations. SAO filtering is a type of loop filtering used in video coding. In general, the addition of offset values to pixels in a video frame (e.g., a reconstructed image) may in some instances improve coding without greatly increasing the bit overhead needed to store or transmit encoded video data. The improvement in coding that potentially results from SAO filtering may be, for example, that a decoded image more closely resembles an original image. SAO techniques allow for different offset values to be applied to different pixels (or blocks of pixels) depending on pixel (or block) classification metrics, such as edge metrics, band metrics, or other types of metrics.

In some configurations, an SAO filter unit may be configured to perform two types of SAO filtering, generally referred to in this disclosure as band offset filtering and edge offset filtering. The techniques of this disclosure, which relate to signaling of offset vales, are generally applicable to both types of SAO filtering. An SAO filter unit may also at times apply no offset, which as will be explained in more below, can itself be considered a third type of SAO filtering. The type of offset filtering applied by an SAO filter may be either explicitly or implicitly signaled to a video decoder. When applying edge offset filtering, pixels can be classified based on edge information of a coding unit, and an offset can be determined for pixels based on the edge classification. As will be explained in greater detail below, there are typically four variations of edge-based SAO, where the value of a pixel is compared to two of its eight neighboring pixels. Which two pixels are used for comparison depends on which variation of edge-based offset is used. Based on the magnitude difference, an offset is added to the pixel value.

When applying band offset filtering, pixels can be classified into different bands based on a pixel value, such as an intensity value, with each band having an associated offset. A band includes a range of pixel values. For example, pixel values ranging from 0 to 255 may be divided into 32 equal bands (labeled 0 to 31), such that pixel values 0-7 are a first band, pixel values 8-15 are a second band, pixel values 16-23 are a third band, and so on for all thirty-two bands. The bands can be used for determining which particular offset value to apply to a pixel or group of pixels. For example, if a pixel has a value of 10 (which is within the second band, i.e. values 8-15, in the example above), then an offset associated with the second band can be added to the pixel value.

For purposes of signaling and generating the offsets for the various bands, the bands may be grouped into two or more groups. For band offset filtering, pixels may, for example, be categorized into thirty-two bands (bands 0-31) as described above, and the bands may be grouped into two groups (e.g., two groups of sixteen bands, one group of four bands and one group of twenty-eight bands, one group of eight bands and one group of twenty-four bands, or other such groupings). The groupings of bands can be used for determining the order in which the offset values for the bands are signaled in the encoded video bitstream, and/or can be used to determine if a particular band has an offset value other than zero. Offsets for the bands may be signaled using differential coding techniques in which a current value is signaled as a difference between the current value and a previous value.

In some techniques proposed for inclusion in the High Efficiency Video Coding (HEVC) standard, SAO filtering may be enabled and disabled at the slice level, and furthermore, SAO filtering may be enabled and disabled separately for luma and chroma samples. For example, for a particular slice of video data, both luma and chroma samples may be SAO filtered; neither luma nor chroma samples may be SAO filtered; or one of luma and chroma samples may be SAO filtered while the other is not. When SAO filtering is enabled for a slice, then SAO type and offset values are signaled at an largest coding unit (LCU) level. As introduced above, the SAO type can include band offset filtering, edge offset filtering, or no SAO filtering. Thus, even if SAO filtering is enabled for a particular slice, some LCUs of that slice may not be SAO filtered (i.e. some LCUs will have an SAO type of no SAO filtering). In some instances, the SAO type and the offset values are signaled with a series of merge flags, where a true value for a first merge flag indicates the offset type and the offset values for the LCU are inherited from a left neighboring LCU and a true value for a second merge flag indicates the SAO type and the offset values are inherited from an above neighboring LCU. If both merge flags are false, then a new SAO type and new offset values are sent for the LCU.

This disclosure describes techniques for generating binary representations of the offset values. According to some currently used techniques, offset values are binarized using truncated unary coding. In truncated unary coding, a series of 1's and a terminating 0 is used to convey a value. For example, 110 represents 2, 1110 represents 3, and so on. A maximum value, if known, can be represented without the terminating the 0. For example, if a set of values has a maximum value of 4, then 3 can be represented as 1110 while 4 is represented as 1111. As 4 is known to be the maximum value, a video coder can interpret 1111 as 4 without receiving a terminating 0. Offset values have maximum possible values that depend on an internal bitdepth. For example, offsets may have values of 0 to 7 for 8-bit bitdepth and maximum values of 31 for 10-bit bitdepth. Using truncated unary coding, the worst case number of when binarizing the values is large (i.e., 7 for 8-bit bitdepth and 31 for 10-bit bitdepth). This disclosure proposes techniques for reducing the worst case number of bins by using different coding methods of offset values for SAO.

According to the techniques of this disclosure, an offset value can be conveyed using a prefix value and a suffix value, where the combination of the suffix value and the prefix value identify the offset value. The prefix value can be a truncated unary value, and the suffix value can be a fixed length codeword. Tables 1 and 2 below provide examples of how the techniques of this disclosure may be implemented. In the examples of Tables 1 and 2, a prefix value identifies a range of offset values, and a suffix value identifies a specific offset value within that range of offset values. For example, in Table 2, the prefix 1110 in a bitstream identifies the range of offset values from 4 to 7. A fixed length, 2-bit suffix value can then be signaled in the bitstream to identify a specific offset value within that range of offset values. For example, the prefix 1110 with the suffix 00 may be used to signal an offset value of 4; the prefix 1110 with the suffix 01 may be used to signal an offset value of 5; the prefix 1110 with the suffix 10 may be used to signal an offset value of 6; and, the prefix 1110 with the suffix 11 may be used to signal an offset value of 7.

The techniques of the present disclosure potentially improve coding efficiency by reducing the worst case complexity scenario. For instance, using only truncated unary coding as described above, an offset value of 31 would require 31 bits to signal. Using the techniques of this disclosure, an offset value of 31 can be signaled using only 9 bits (i.e. the prefix 11111 and the suffix 1111).

TABLE 1
(8-bit internal bitdepth cases, maximum offset value = 7)

| | Prefix | Suffix | |
|---|---|---|---|
| Offset value | Truncated unary | Fixed length | Suffix range |
| 0 | 0 | — | — |
| 1 | 10 | — | — |
| 2-3 | 110 | X | 0 to 1 |
| 4-7 | 111 | XX | 0 to 3 |

TABLE 2
(10-bit internal bitdepth cases, maximum offset value = 31)

| | Prefix | Suffix | |
|---|---|---|---|
| Offset value | Truncated unary | Fixed length | Suffix range |
| 0 | 0 | — | — |
| 1 | 10 | — | — |
| 2-3 | 110 | X | 0 to 1 |
| 4-7 | 1110 | XX | 0 to 3 |
| 8-15 | 11110 | XXX | 0 to 7 |
| 16-31 | 11111 | XXXX | 1 to 15 |

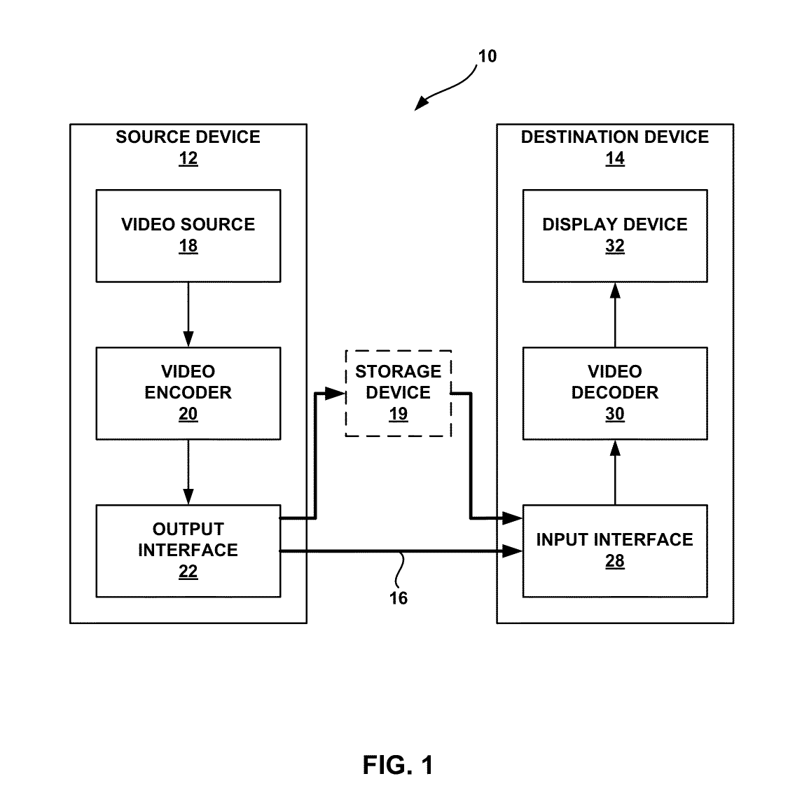

FIG. 1 is a block diagram illustrating an example video encoding and decoding system 10 that may utilize the SAO coding techniques described in this disclosure. As shown in FIG. 1, system 10 includes a source device 12 that generates encoded video data to be decoded at a later time by a destination device 14, and as will be described in more detail below, this encoding and decoding of video data may include coding offset values for use in SAO filtering. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 19. Similarly, encoded data may be accessed from storage device 19 by input interface. Storage device 19 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 19 may correspond to a file server or another intermediate storage device that may hold the encoded video generated by source device 12. Destination device 14 may access stored video data from storage device 19 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 19 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 19 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 19, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Document HCTVC-11003, Bross et al., “High Efficiency Video Coding (HEVC) Text Specification Draft 7 (also referred to as “HEVC Working Draft 7” or “HEVC WD7”), Joint Collaborative Team on Video Coding (JCT-VC) of ITU-T SG16 WP3 and ISO/IEC JTC1/SC29/WG11, 9^{th} Meeting: Geneva, Switzerland, Apr. 27, 2012 to May 7, 2012, which, as of 17 Jun. 2013, is downloadable from http://phenix.it-sudparis.eu/jct/doc_end_user/documents/9_Geneva/wg11/JCTVC-11003-v3.zip, and is hereby incorporated by reference in its entirety. Development of the HEVC standard is ongoing, and a newer draft of the upcoming HEVC standard, referred to as “HEVC Working Draft 10” or “HEVC WD10,” is described in Bross et al., “Editors' proposed corrections to HEVC version 1,” Joint Collaborative Team on Video Coding (JCT-VC) of ITU-T SG16 WP3 and ISO/IEC JTC1/SC29/WG11, 13^{th} Meeting, Incheon, KR, April 2013, which as of 17 Jun. 2013, is available from http://phenix.int-evey.fr/jct/doc_end_user/documents/13_Incheon/wg11/JCTVC-M0432-v3.zip, the entire content of which is hereby incorporated by reference.

Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

As introduced above, the JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more transform units (TUs). Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

SAO coding is currently under consideration for adoption into the HEVC standard. In general, the addition of offset values to pixels in a video frame may improve the quality of reconstructed video quality without greatly increasing the bit overhead needed to store or transmit encoded video data. SAO techniques allow for different offset values to be applied to different pixels (or blocks) depending on pixel (or block) classification metrics. Possible classification metrics include band metrics and activity metrics such as edge metrics. A description of offset classifications can be found in C.-M. Fu, C.-Y. Chen, C.-Y. Tsai, Y.-W. Huang, S. Lei, “CE13: Sample Adaptive Offset with LCU-Independent Decoding,” JCT-VC Contribution, E049, Geneva, February 2011, which is hereby incorporated by reference.

In the current SAO implementation in the HEVC standard, each partition (which consists of a set of LCUs) can have one of three offset types, which are also referred to as pixel classifications. The three classifications include no offset, band classification based offset type 0/1, and edge classification based type 0/1/2/3. Each band classification offset type has sixteen possible offset values, while each edge classification based type has four possible offset values. If one of these offset types is chosen to be used for the partition, information indicating the corresponding offset type and the offset values are signaled in the encoded video bitstream.

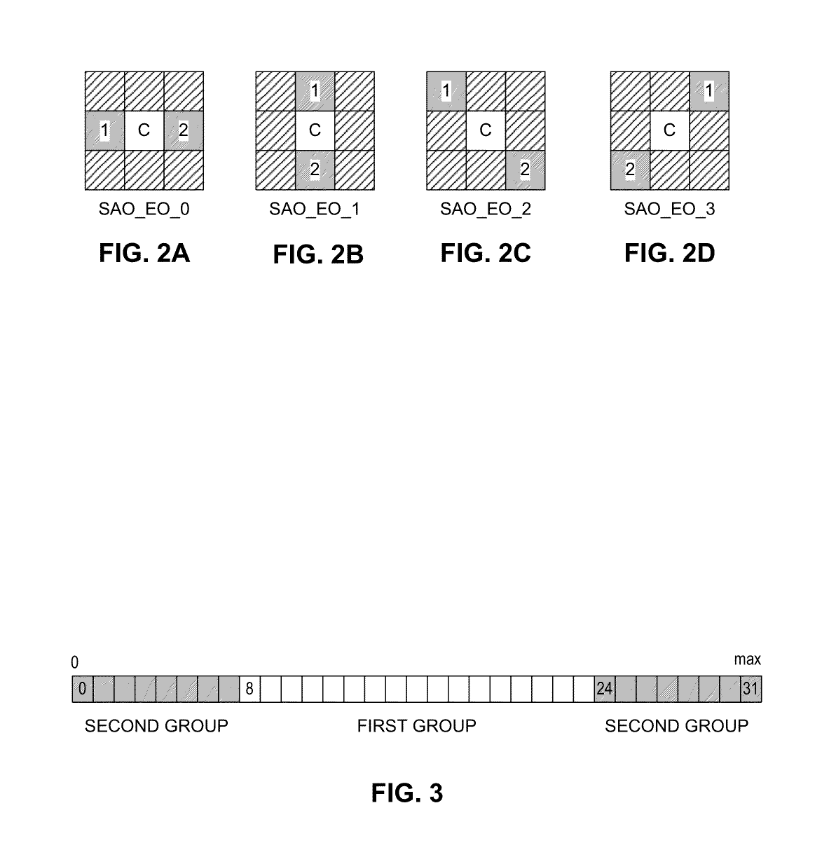

FIGS. 2A-2D are conceptual diagrams showing the four possible edge offset classifications currently proposed for HEVC. The edge offset type classifies each pixel based on edge information. For each of the edge classifications shown in FIGS. 2A-2D, an edge type for the current pixel is calculated by comparing the value of the current pixel (C) to the values of neighboring pixels (1 and 2). For SAO edge offset of classification zero (SAO_EO_{—}0) shown in FIG. 2A, the current pixel (pixel C) is compared to the left neighbor pixel (pixel 1) and the right neighbor pixel (pixel 1). For SAO edge offset of classification one (SAO_EO_{—}1) shown in FIG. 2B, the current pixel (pixel C) is compared to the top neighbor pixel (pixel 1) and the bottom neighbor pixel (pixel 2). For SAO edge offset of classification two (SAO_EO_{—}2) shown in FIG. 2C, the current pixel (pixel C) is compared to the upper left neighbor pixel (pixel 1) and the bottom right neighbor pixel (pixel 2). For SAO edge offset of classification three (SAO_EO_{—}3) shown in FIG. 2D, the current pixel (pixel C) is compared to the upper right neighbor pixel (pixel 1) and the bottom left neighbor pixel (pixel 2).

The four edge offset classifications can each have an edge type with 5 possible integer values ranging from −2 to 2. Initially, the edge type of the current pixel is assumed to be zero. If the value of current pixel C is equal to values of both the left and right neighbor pixels (1 and 2), the edge type remains at zero. If the value of the current pixel C is greater than the value of neighbor pixel 1, the edge type is increased by one. If the value of the current pixel C is less than the value of neighbor pixel 1, the edge type is decreased by one. Likewise, if the value of the current pixel C is less than the value of neighbor pixel 2, the edge type is increased by one, and if the value of the current pixel C is less than the value of the neighbor pixel 2, the edge type is decreased by 1.

As such, the current pixel C may have an edge type of −2, −1, 0, 1, or 2. The edge type is −2 if the value of current pixel C is less than both values of neighbor pixels 1 and 2. The edge type is −1 if the value of current pixel C is less than one neighbor pixel, but equal to the other neighbor pixel. The edge type is 0 if the value of current pixel C is the same as both neighbor pixels, or if the value of current pixel C is greater than one neighbor pixel, but less than the other neighbor pixel. The edge type is 1 if the value of the current pixel C is greater than one neighbor pixel, but equal to the other neighbor pixel. The edge type is 2 if the value of the current pixel C is greater than both values of neighbor pixels 1 and 2. For each non-zero edge type value, four offset values are determined and signaled in the encoded video bitstream for use by a decoder (i.e., eoffset₋₂, eoffset₋₁, eoffset₁, eoffset₂).

In view of the above description, for each edge offset classification, edge type values may be computed for a pixel using the following equations:

EdgeType=0;

if (C>Pixel 1) EdgeType=EdgeType+1;

if (C<Pixel 1) EdgeType=EdgeType−1;

if (C>Pixel 2) EdgeType=EdgeType+1;

if (C<Pixel 2) EdgeType=EdgeType−1;

This disclosure describes techniques for signaling offset values in an encoded video bitstream. Accordingly, when a video encoder codes video data using edge-based SAO, the techniques of this disclosure may be used to signal values for eoffset₋₂, eoffset₋₁, eoffset₁, eoffset₂ in an encoded video bitstream.

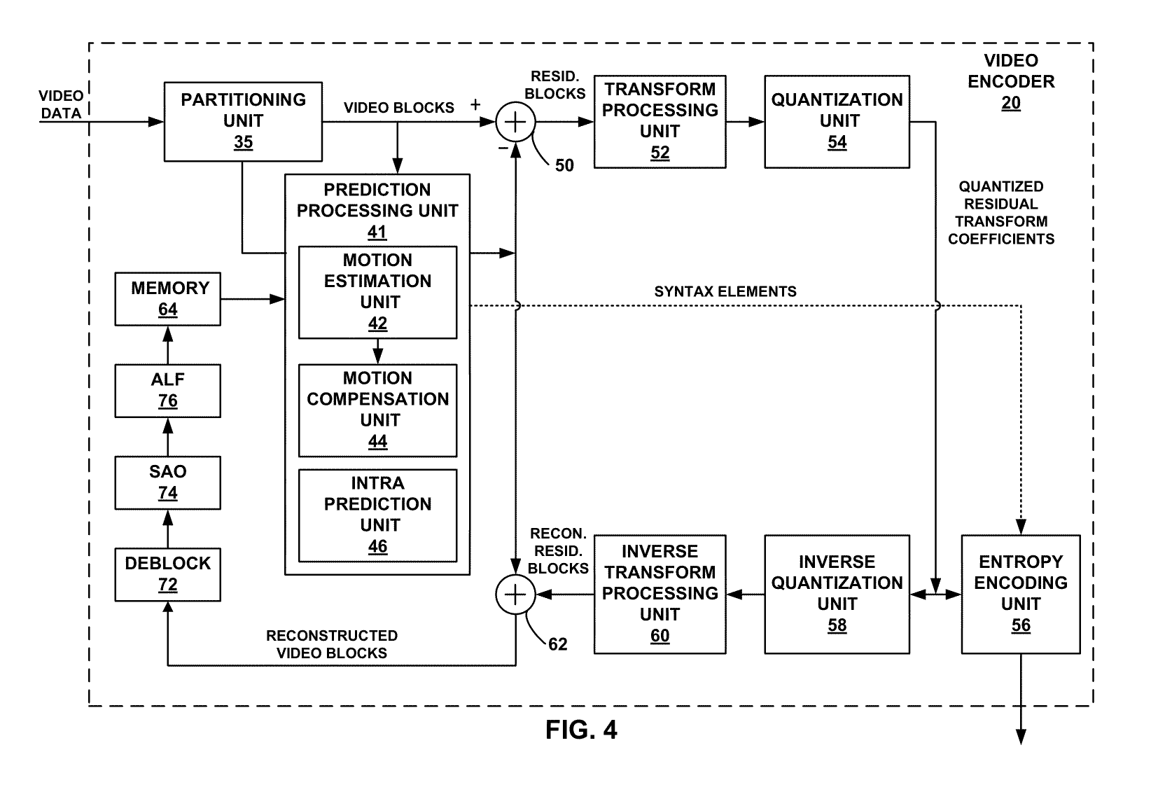

FIG. 3 is a conceptual diagram showing example bands that may be used in band-based SAO classification. Each rectangle in FIG. 3 represents a band. The example of FIG. 3 shows 32 bands, i.e. bands 0-31, and some of the bands, such as band 0, band 8, band 24, and band 31 have been labeled. In some implementations more or fewer bands may be used. For band-based offset, pixels are classified into different bands based on pixel values, such as intensity values. For purposes of example, assume pixel values range from 0-255 (e.g. 8-bit bitdepth), although other ranges such as 0-1023 (e.g. 10-bit bitdepth) may also be used. In such an example the max value shown in FIG. 3 would be equal to 255, and each of the thirty-two bands shown in FIG. 3 would have a range of 8. The left-most band (i.e. band 0 in FIG. 3) would be pixel values 0-7, the next band (i.e. band 1 in FIG. 3) would be for pixel values of 8-15, the next band (i.e. band 2) would be for pixel values 16-23, and so on, until the right most band (i.e. band 31 in FIG. 3) which would be for pixel values 248-255. For band offset, pixels are classified into different bands based on a pixel value such as an intensity value. Based on which band a pixel value falls in, an offset is added to the pixel. For example, if a pixel has a value of 19, then according to this current example, the pixel value falls within band 2 which ranges from pixel value 16 to 23. Thus, an offset associated with band 2 would be added to the pixel value of 19.

For purposes of signaling the offset values associated with each bands, the bands can be grouped into two or more groups. In some implementations, the sixteen bands in the center (bands 8-23) are classified into one group and the remaining bands (bands 0-7 and 24-31) are classified into a second group. For each group of bands, 16 offset values (i.e., boffset₀, . . . , boffset₁₅) are determined and are signaled in the encoded video bitstream for use by a video decoder. In some implementations, all the offset values for a group, such as the second group, may be assumed to be 0, in which case no signaling of offset values for that group needs to be included in the encoded video bitstream. Having two groups of sixteen bands is just one example of how the bands may be grouped. In another example, each band of a group of four bands may have an associated non-zero offset value, while the remaining 28 bands may all be inferred to have no offset or an offset value of 0. In other examples, the bands may be grouped into three or more groups or may be treated as one single group.

In the example of FIG. 3, the middle sixteen bands (bands 8-23) constitute a first group of bands, while the eight left-most bands (band 0-7) constitute the first portion of a second group of bands, and the eight right-most bands (bands 24-31) constitute a second portion of the second group of bands. For each group of bands, video encoder 20 may determine sixteen offset values (i.e., boffset₀, . . . , boffset₁₅) and signal in the encoded video bitstream information allowing video decoder 30 to reconstruct the sixteen offset values. If one or more groups are all assumed to have no non-zero offset values, then information for reconstructing the offset values for that group may not need to be explicitly signaled in the encode video bitstream. This disclosure generally describes techniques for signaling offset values in an encoded video bitstream. Accordingly, video encoder 20 codes video data using band-based SAO, the techniques of this disclosure may be used to signal values for boffset₀, . . . , boffset_{N-1} where N represents the number of bands that have non-zero offset values.

Some HEVC proposals implement maximum values for offset values. For example, in HEVC WD 7, for an 8-bit bitdepth, the maximum value of an offset is set at 7, and for a 10-bit bitdepth, the maximum value of an offset is set at 31. Currently, these offset values are binarized with truncated unary coding, as shown in TABLE 3 below.

TABLE 3
8 bit internal bitdepth case, maximum offset value = 7

| Offset value | Truncated unary |
|---|---|
| 0 | 0 |
| 1 | 10 |
| 2 | 110 |
| 3 | 1110 |
| 4 | 11110 |
| 5 | 111110 |
| 6 | 1111110 |
| 7 | 1111111 |

In the example of TABLE 3, the worst case number of bins is relatively large. For example, to code an offset vale of 7, 7 bits requiring 7 bins are needed. For 10-bit bitdepth, the worst case scenario is even worse, with a possibility of 31 bins. As introduced above, this disclosure describes techniques that may reduce the worst case number of bins by using different coding methods for SAO offset values.

In one example, described in TABLE 1 and TABLE 2 above, the techniques of this disclosure may decrease the maximum number of bins from 7 to 5 for 8-bit internal bitdepth, and from 31 to 9 for 10-bit internal bitdepth cases, respectively. Referring back to TABLE 1, the worst case complexity scenario of 5 bins may occur for offset values of 4 to 7, which are signaled using a 3-bit prefix (111 in the example of TABLE 1) and a two-bit suffix value. Referring back to TABLE 2, the worst case complexity scenario of 9 bins may occur for offset values between 16 and 31, which are signaled using a 5-bit prefix (11111 in the example of TABLE 2) and a 4-bit suffix.

As can be seen in the examples of TABLES 1 and 2, instead of coding an offset value using a unary codeword (as in TABLE 3), an offset value can be coded as a combination of a prefix value and a suffix value, where the combination of the prefix value and the suffix value identify the offset value. The prefix value may be a truncated unary code while the suffix value may be a fixed length code.

As an example, referring to TABLE 1, an offset value of 6 can be coded as a combination of the prefix 111 and a suffix value. An offset value of 7 can also be coded with the prefix of 111 but with a different suffix. The suffix values used to code offset values of 6 and 7 are two bits each in the example of TABLE 1. Thus the total bits used to code the offset values of 6 and 7 is five bits (three bits for the prefix and two bits for the suffix). In contrast, in the example of TABLE 3, seven bits are needed to code the offset values of 6 and 7. Thus, in the example of TABLE 1, the techniques of this disclosure reduce the worst case scenario for coding an offset value from 7 bits to 5 bits. The best case scenarios, however, for TABLE 1 remains the same as compared to TABLE 2. As can be seen by comparing TABLE 3 to TABLET, offset values of 0 and 1 are still coded with one and two bits, respectively.

The following pseudocode illustrates one example technique for determining a truncation point a function of bit depth (i.e., for N bit internal bitdepth cases).

```
maxSymbol = function of N
codeSaooffset (code, maxSymbol)
{
  Bool bCodeLast = 0;
  bitDepth = 0;
  bitDepthMax = 0;
  if( code == 0 )
  {
  output( 0 );
  }
  else
  {
  bitDepth = floor (log2(code));
  bitDepthMax = floor (log2(maxSymbol));
  bCodeLast = (bitDepth < bitDepthMax);
  output( 1 );
  for ( i=0; i< bitDepth; i++ )
  {
    output( 1 );
  }
  if( bCodeLast )
  {
    output( 0 );
  }
  for ( i=0; i < bitDepth; i++ )
  {
    bin = (code & (0x01 << i))? 1:0;
    output( bin );
  }
  }
}
```

For the techniques of this pseducode, the truncation point depends on the internal bitdepth (i.e., bin3 for bitdepth 8, bin4 for bitdepth 9, and bin5 for bitdepth 10).

According to another technique of this disclosure, the binarization methods used for coding the prefix value and suffix value may be the same as methods used for coding other values in order to unify the coding process and reduce coder complexity. For example, the binarization methods used for coding the prefix values and suffix values of this disclosure may utilize the same binarization method as last position coding (in coefficient coding) to potentially more unify the coding process.

According to the techniques of this disclosure, the prefix part of the code can be coded with context-based entropy coding (e.g., context adaptive binary arithmetic coding (CABAC)). For example, bin0 of prefix can be coded with ctx0, and other bins of prefix can be coded with ctx1. Or bin0 with ctx0, bin1 with ctx1, and other with ctx2. Or only subset of prefix part can be coded with contexts (i.e., only N bins of prefix part are coded with contexts).

According to the techniques of this disclosure, the suffix part of the code can be coded in either a bypass mode (i.e., with a fixed probability model) or with contexts (i.e., with adaptive probability models). When contexts are used, one ctx for all suffix part may be used, which can be shared with the last ctx of prefix or can have separate one or more contexts. When it is coded with bypass bins, it can be coded in group (i.e., all bypass bins for 4 offset values are coded at the same time, not interleaved with prefix)

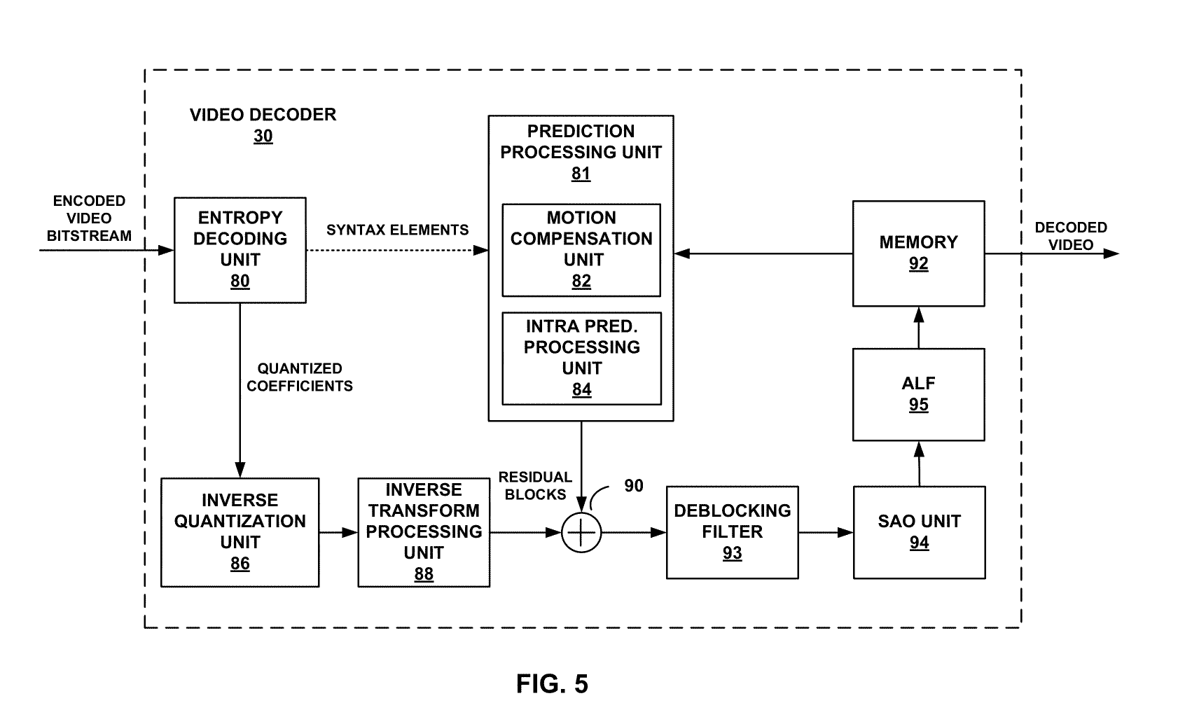

FIG. 4 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 4, video encoder 20 includes a partitioning unit 35, prediction processing unit 41, summer 50, transform processing unit 52, quantization unit 54, entropy encoding unit 56, and memory 64. Prediction processing unit 41 includes motion estimation unit 42, motion compensation unit 44, and intra-prediction unit 46. For video block reconstruction, video encoder 20 also includes inverse quantization unit 58, inverse transform processing unit 60, summer 62, deblocking filter 72, SAO unit 74, and ALF 76. Although deblocking filter 72, SAO unit 74, and ALF 76 are shown in FIG. 4 as being in loop filters, in other configurations, deblocking filter 72, SAO unit 74, and ALF 76 may be implemented as post loop filters.

As shown in FIG. 4, video encoder 20 receives video data, and partitioning unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra-prediction unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes. For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction unit 46 may calculate ratios from the distortions and rates for the various encoded blocks to determine which intra-prediction mode exhibits the best rate-distortion value for the block.

In any case, after selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 41 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in memory 64. The reference block may be used by motion estimation unit 42 and motion compensation unit 44 as a reference block to inter-predict a block in a subsequent video frame or picture.

Prior to storage in memory 64, the reconstructed residual block can be filtered by one or more filters. If desired, deblocking filter 72 may also be applied to filter the reconstructed residual blocks in order to remove blockiness artifacts. Other loop filters, such as ALF 76 and SAO unit 74 (either in the coding loop or after the coding loop) may also be used to smooth pixel transitions, or otherwise improve the video quality. The reference block, after being filtered by one or more of deblocking filter unit 72, SAO unit 74, and ALF 76, may be used by motion estimation unit 42 and motion compensation unit 44 as a reference block to inter-predict a block in a subsequent video frame or picture.

SAO unit 74 can determine offset values for SAO filtering in a manner that improves video coding quality. Improving video coding quality may, for example, involve determining offset values that make a reconstructed image more closely match an original image. Video encoder 20 may, for example, code the video data using multiple passes with different SAO types and different offset values and choose, for inclusion in an encoded bitstream, the SAO type and offset values that offer the best coding quality, as determined based on a desire rate-distortion tradeoff.

In some configurations, SAO unit 74 may be configured to apply two types of offset (e.g., band offset and edge offset) as described above. SAO unit 74 may also at times apply no offset, which can itself be considered a third type of offset. The type of offset applied by SAO unit 74 may be either explicitly or implicitly signaled to a video decoder. When applying edge offset, pixels can be classified based on edge information in accordance with FIGS. 2A-2D and an offset value can be determined based on the edge classification. When applying band-based offset, SAO unit 74 can classify pixels into different bands based on a pixel value, such as an intensity value, with each band having an associated offset.

Regardless of whether the selected SAO type is band-based SAO or edge-based SAO, video encoder 20 may code the offset values as a combination of a prefix value and a suffix value. The prefix value may, for example, be a truncated unary value that can be CABAC coded by entropy encoding unit 56.

In this manner, video encoder 20 of FIG. 4 represents an example of a video encoder configured to determine an offset value for an SAO operation and generate a prefix value and a suffix value such that the combination of the suffix value and the prefix value identify the offset value.

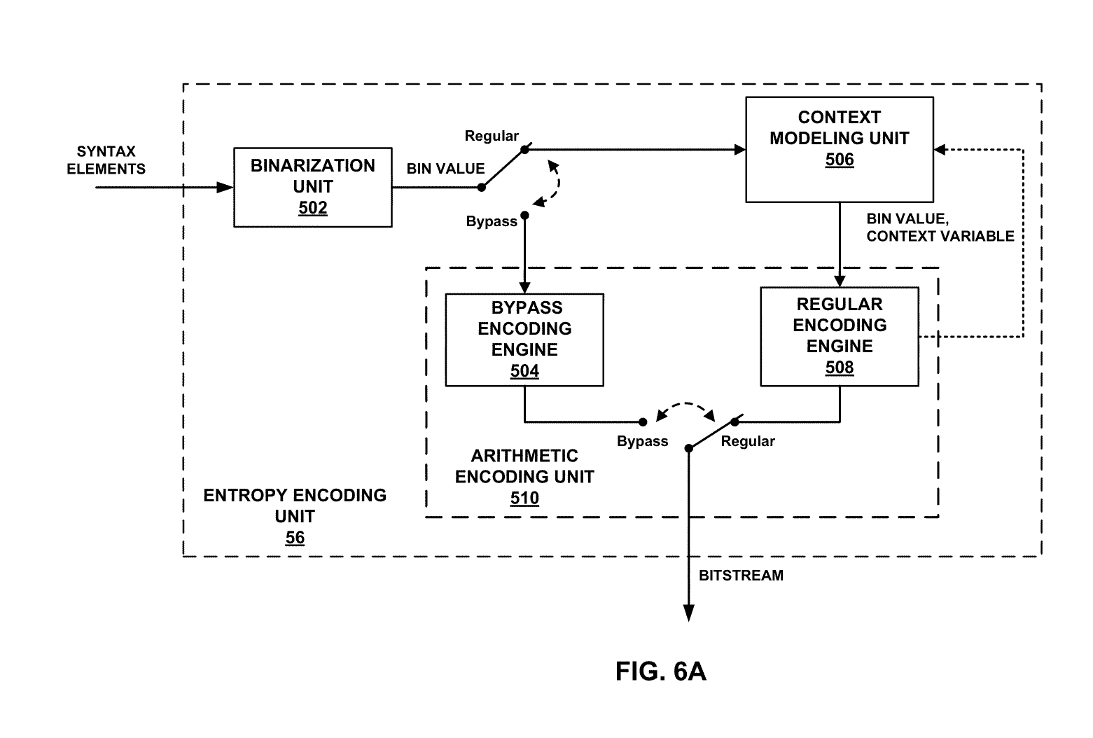

FIG. 5 is a block diagram illustrating an example video decoder 30 that may implement the techniques described in this disclosure. In the example of FIG. 5, video decoder 30 includes an entropy decoding unit 80, prediction processing unit 81, inverse quantization unit 86, inverse transform processing unit 88, summer 90, deblocking filter 93, SAO unit 94, ALF 95, and reference picture memory 92. Prediction processing unit 81 includes motion compensation unit 82 and intra-prediction unit 84. Video decoder 30 may, in some examples, perform a decoding pass generally reciprocal to the encoding pass described with respect to video encoder 20 from FIG. 4.

During the decoding process, video decoder 30 receives an encoded video bitstream that represents video blocks of an encoded video slice and associated syntax elements from video encoder 20. Entropy decoding unit 80 of video decoder 30 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra-prediction unit 84 of prediction processing unit 81 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in reference picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform processing unit 88 with the corresponding predictive blocks generated by motion compensation unit 82. Summer 90 represents the component or components that perform this summation operation. The decoded video blocks formed by summer 90 can then be filtered by a deblocking filter 93, SAO unit 94, and ALF 95. The decoded video blocks in a given frame or picture are then stored in reference picture memory 92, which stores reference pictures used for subsequent motion compensation. Reference picture memory 92 also stores decoded video for later presentation on a display device, such as display device 32 of FIG. 1. SAO unit 94 can be configured to apply the same filtering (e.g., edge offset and band offset) as SAO unit 74 discussed above.

In this manner, video decoder 30 of FIG. 5 represents an example of a video decoder configured to receive a prefix value, receive a suffix value, and based on a combination of the suffix value and the prefix value, determine an offset value for a sample adaptive offset filtering operation. The prefix value may be a truncated unary value and may be coded using contexts. In some instances, a subset of the prefix value may be coded using contexts. The suffix value may be a fixed length codeword and may be coded using bypass coding. The suffix value may also be coded using contexts.

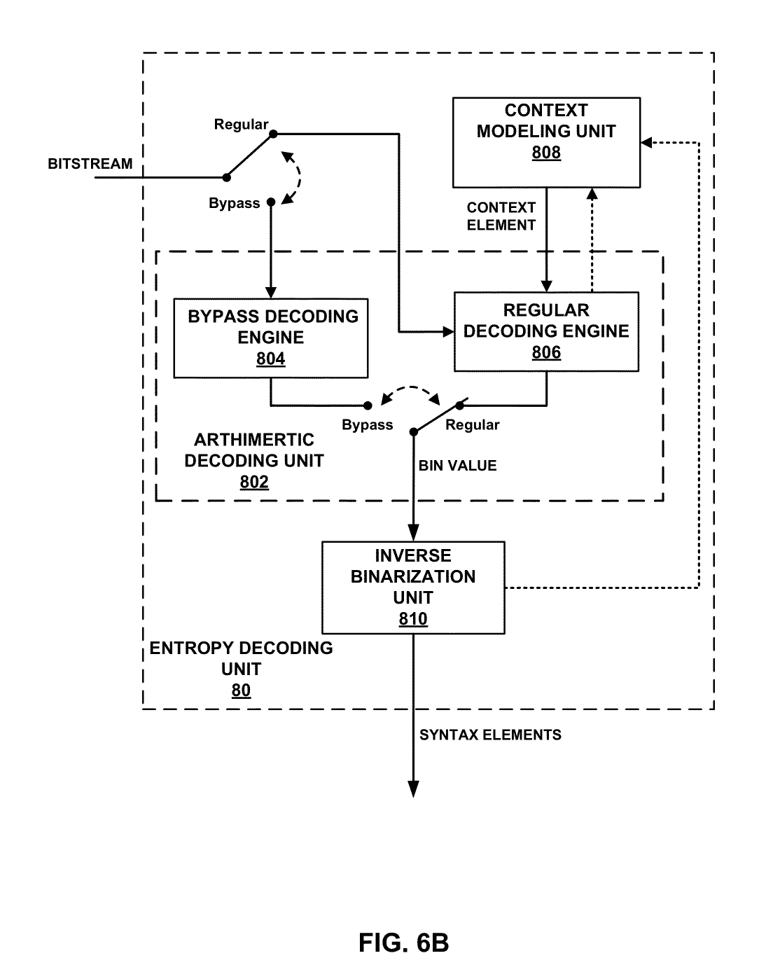

FIG. 6A is a block diagram that illustrates an example entropy encoding unit 56 that may be used in accordance with the techniques described in this disclosure. The entropy encoding unit 56 illustrated in FIG. 6A may be a CABAC encoder. The example entropy encoding unit 56 may include a binarization unit 502, an arithmetic encoding unit 510, which includes a bypass encoding engine 504 and a regular encoding engine 508, and a context modeling unit 506.

Entropy encoding unit 56 may receive one or more syntax elements, such as the either of the suffix value and prefix value described above. Binarization unit 502 receives a syntax element and produces a bin string (i.e., binary string). Binarization unit 502 may use, for example, any one or combination of the following techniques to produce a bin string: fixed length coding, unary coding, truncated unary coding, truncated Rice coding, Golomb coding, exponential Golomb coding, and Golomb-Rice coding. Further, in some cases, binarization unit 502 may receive a syntax element as a binary string and simply pass-through the bin values. In one example, binarization unit 502 receives the suffix and prefix values described above and produces a bin string.

Arithmetic encoding unit 510 is configured to receive a bin string from binarization unit 502 and perform arithmetic encoding on the bin string. As shown in FIG. 6A, arithmetic encoding unit 510 may receive bin values from a bypass path or the regular coding path. Bin values that follow the bypass path may be bins values identified as bypass coded and bin values that follow the regular encoding path may be identified as CABAC-coded. Consistent with the CABAC process described above, in the case where arithmetic encoding unit 510 receives bin values from a bypass path, bypass encoding engine 504 may perform arithmetic encoding on bin values without utilizing an adaptive context assigned to a bin value. In one example, bypass encoding engine 504 may assume equal probabilities for possible values of a bin.

In the case where arithmetic encoding unit 510 receives bin values through the regular path, context modeling unit 506 may provide a context variable (e.g., a context state), such that regular encoding engine 508 may perform arithmetic encoding based on the context assignments provided by context modeling unit 506. The context assignments may be defined according to a video coding standard, such as the upcoming HEVC standard. Further, in one example context modeling unit 506 and/or entropy encoding unit 56 may be configured to assign contexts to bins of the suffix or prefix values described above or to portions of the suffix or prefix values described above. The techniques may be incorporated into HEVC or another video coding standard. The context models may be stored in memory. Context modeling unit 506 may include a series of indexed tables and/or utilize mapping functions to determine a context and a context variable for a particular bin. After encoding a bin value, regular encoding engine 508 may update a context based on the actual bin values.

FIG. 6B is a block diagram that illustrates an example entropy decoding unit 80 that may implement the techniques described in this disclosure. Entropy decoding unit 80 receives an entropy encoded bitstream and decodes syntax elements from the bitstream. Syntax elements may include the suffix and prefix values described above. The example entropy decoding unit 80 in FIG. 6B includes an arithmetic decoding unit 802, which may include a bypass decoding engine 804 and a regular decoding engine 806. The example entropy decoding unit 80 also includes context modeling unit 808 and inverse binarization unit 810. The example entropy decoding unit 80 may perform the reciprocal functions of the example entropy encoding unit 56 described with respect to FIG. 6A. In this manner, entropy decoding unit 80 may perform entropy decoding based on the techniques described herein.

Arithmetic decoding unit 802 receives an encoded bit stream. As shown in FIG. 6B, arithmetic decoding unit 802 may process encoded bin values according to a bypass path or the regular coding path. An indication whether an encoded bin value should be processed according to a bypass path or a regular pass may be signaled in the bitstream with higher level syntax. Consistent with the CABAC process described above, in the case where arithmetic decoding unit 802 receives bin values from a bypass path, bypass decoding engine 804 may perform arithmetic encoding on bin values without utilizing a context assigned to a bin value. In one example, bypass decoding engine 804 may assume equal probabilities for possible values of a bin.

In the case where arithmetic decoding unit 802 receives bin values through the regular path, context modeling unit 808 may provide a context variable, such that regular decoding engine 806 may perform arithmetic encoding based on the context assignments provided by context modeling unit 808. The context assignments may be defined according to a video coding standard, such as HEVC. The context models may be stored in memory. Context modeling unit 808 may include a series of indexed tables and/or utilize mapping functions to determine a context and a context variable portion of an encoded bitstream. Further, in one example context modeling unit 808 and/or entropy decoding unit 80 may be configured to assign contexts to bins of the suffix and prefix values. After decoding a bin value, regular decoding engine 806, may update a context based on the decoded bin values. Further, inverse binarization unit 810 may perform an inverse binarization on a bin value and use a bin matching function to determine if a bin value is valid. The inverse binarization unit 810 may also update the context modeling unit based on the matching determination. Thus, the inverse binarization unit 810 outputs syntax elements according to a context adaptive decoding technique.

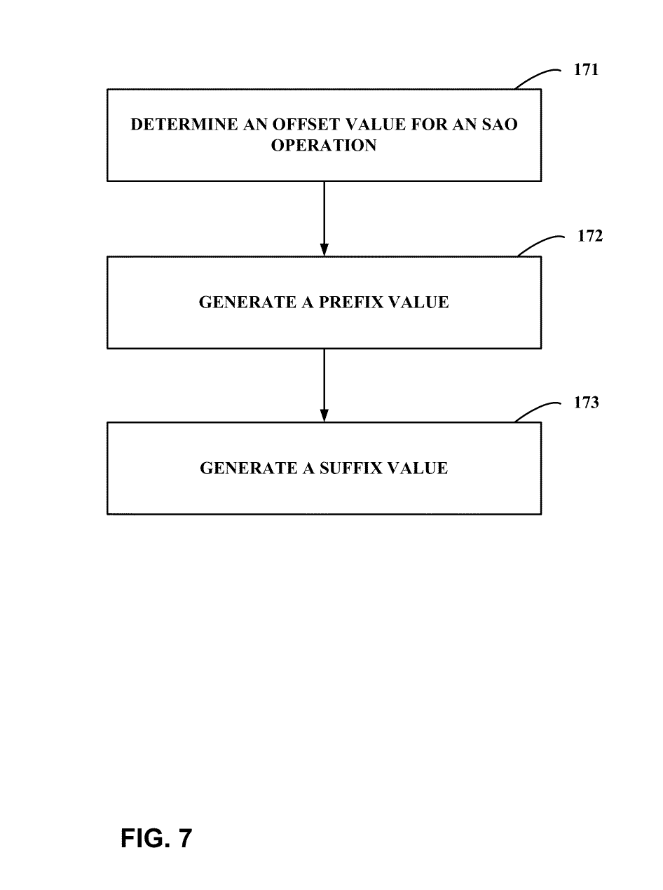

FIG. 7 is a flow diagram illustrating a method for encoding video data in accordance with the techniques of this disclosure. The techniques of FIG. 7 may, for example, be performed by video encoder 20. As part of a video encoding process, video encoder 20 determines an offset value for an SAO operation (171). To signal the determined offset value, video encoder 20 may generate, for inclusion in an encoded video bitstream, a prefix value (172) and also generate, for inclusion in the encoded video bitstream, a suffix value (173) such that the combination of the suffix value and the prefix value identify the offset value. The prefix value may, for example, be a truncated unary value, and the suffix value may be a fixed length value, as illustrated above in the examples of TABLE 1 and TABLE 2.

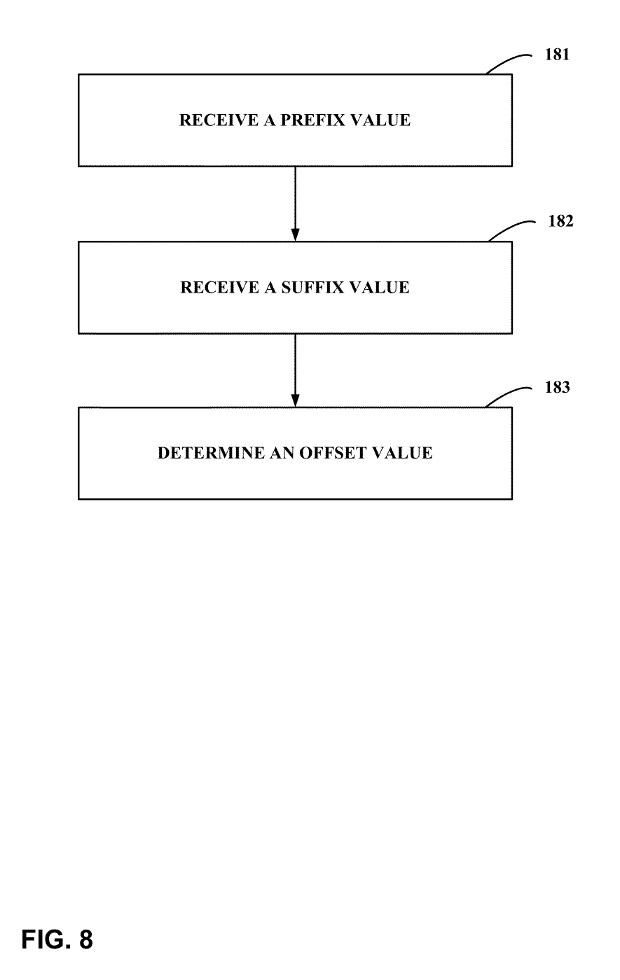

FIG. 8 is a flow diagram illustrating a method for encoding video data in accordance with the techniques of this disclosure. The techniques of FIG. 8 may, for example, be performed by video decoder 30. As part of a video decoding process, video decoder 30 may receive a prefix value in a bitstream of encoded video data (181). Video decoder 30 may also receive a suffix value in the bitstream of encoded video data (182). The combination of the suffix value and the prefix value can identify the offset value. Thus, based on the suffix value and the prefix value, video decoder 30 can determine an offset value for a sample adaptive offset filtering (SAO) operation.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for decoding video data, the method comprising:
receiving a prefix value in a bitstream of encoded video data;
receiving a suffix value in the bitstream of encoded video data;
determining an offset value for a sample adaptive offset filtering (SAO) operation; wherein the combination of the suffix value and the prefix value identify the offset value.

2. The method of claim 1, wherein the prefix value identifies a range of offset values for the offset value.

3. The method of claim 2, wherein the suffix value identifies a specific offset value within the range of offset values for the offset value.

4. The method of claim 1, wherein the prefix value is a truncated unary value.

5. The method of claim 1, wherein the prefix value is coded using contexts.

6. The method of claim 1, wherein a subset of the prefix value is coded using contexts.

7. The method of claim 1, wherein the suffix value is a fixed length codeword.

8. The method of claim 1, wherein the suffix value is coded using bypass coding.

9. The method of claim 1, wherein the suffix value is coded using contexts.

10. The method of claim 1, wherein the SAO operation comprise an edge-based SAO operation.

11. The method of claim 1, wherein the SAO operation comprises a band-based SAO operation.

12. The method of claim 1, further comprising:
adding the offset value to a pixel value as part of performing the SAO operation.

13. The method claim 1, wherein the method is performed by a video decoder.

14. A method for encoding video data, the method comprising:
determining an offset value for a sample adaptive offset filtering (SAO) operation;
generating a prefix value;
generating a suffix value, wherein the combination of the suffix value and the prefix value identify the offset value.

15. The method of claim 14, wherein the prefix value identifies a range of offset values for the offset value.

16. The method of claim 15, wherein the suffix value identifies a specific offset value within the range of offset values for the offset value.

17. The method of claim 14, wherein the prefix value is a truncated unary value.

18. The method of claim 14, wherein the prefix value is coded using contexts.

19. The method of claim 14, wherein a subset of the prefix value is coded using contexts.

20. The method of claim 14, wherein the suffix value is a fixed length codeword.

21. The method of claim 14, wherein the suffix value is coded using bypass coding.

22. The method of claim 14, wherein the suffix value is coded using contexts.

23. The method claim 14, wherein the method is performed by a video encoder.

24. The method of claim 14, wherein the SAO operation comprise an edge-based SAO operation.

25. The method of claim 14, wherein the SAO operation comprises a band-based SAO operation.

26. An apparatus for decoding video data, the apparatus comprising:
a video decoder configured to receive a prefix value in a bitstream of encoded video data; receive a suffix value in the bitstream of encoded video data; and,
determine an offset value for a sample adaptive offset filtering (SAO) operation;
wherein the combination of the suffix value and the prefix value identify the offset value.

27. The apparatus of claim 26, wherein the prefix value identifies a range of offset values for the offset value.

28. The apparatus of claim 27, wherein the suffix value identifies a specific offset value within the range of offset values for the offset value.

29. The apparatus of claim 26, wherein the prefix value is a truncated unary value.

30. The apparatus of claim 26, wherein the prefix value is coded using contexts.

31. The apparatus of claim 26, wherein a subset of the prefix value is coded using contexts.

32. The apparatus of claim 26, wherein the suffix value is a fixed length codeword.

33. The apparatus of claim 26, wherein the suffix value is coded using bypass coding.

34. The apparatus of claim 26, wherein the suffix value is coded using contexts.

35. The apparatus of claim 26, wherein the SAO operation comprise an edge-based SAO operation.

36. The apparatus of claim 26, wherein the SAO operation comprises a band-based SAO operation.

37. The apparatus of claim 26, wherein the video decoder is further configured to add the offset value to a pixel value as part of performing the SAO operation.

38. The apparatus of claim 26, wherein the apparatus comprises at least one of:
an integrated circuit;
a microprocessor; and,
a wireless communication device that includes the video decoder.

39. An apparatus for encoding video data, the apparatus comprising:
a video encoder configured to determine an offset value for a sample adaptive offset filtering (SAO) operation; generate a prefix value; and, generate a suffix value, wherein the combination of the suffix value and the prefix value identify the offset value.

40. The apparatus of claim 39, wherein the prefix value identifies a range of offset values for the offset value.

41. The apparatus of claim 40, wherein the suffix value identifies a specific offset value within the range of offset values for the offset value.

42. The apparatus of claim 39, wherein the prefix value is a truncated unary value.

43. The apparatus of claim 39, wherein the prefix value is coded using contexts.

44. The apparatus of claim 39, wherein a subset of the prefix value is coded using contexts.

45. The apparatus of claim 39, wherein the suffix value is a fixed length codeword.

46. The apparatus of claim 39, wherein the suffix value is coded using bypass coding.

47. The apparatus of claim 39, wherein the suffix value is coded using contexts.

48. The apparatus of claim 39, wherein the apparatus comprise a video encoder.

49. The apparatus of claim 39, wherein the SAO operation comprise an edge-based SAO operation.

50. The apparatus of claim 39, wherein the SAO operation comprises a band-based SAO operation.

51. The apparatus of claim 39, wherein the apparatus comprises at least one of:
an integrated circuit;
a microprocessor; and,
a wireless communication device that includes the video encoder.

52. An apparatus for coding video data, the apparatus comprising:
means for determining an offset value for a sample adaptive offset filtering (SAO) operation;
means for coding a prefix value;
means for coding a suffix value, wherein the combination of the suffix value and the prefix value identify the offset value.

53. The apparatus of claim 52, wherein
the means for coding the prefix value comprise means for decoding the prefix value;
the means for coding the suffix value comprises means for decoding the suffix value.

54. The apparatus of claim 52, wherein
the means for coding the prefix value comprise means for generating the prefix value for inclusion in an encoded video bitstream;
the means for coding the suffix value comprises means for generating the suffix value for inclusion in the encoded video bitstream.

55. A computer readable storage medium storing instructions that when executed cause one or more processors to:
determine an offset value for a sample adaptive offset filtering (SAO) operation;
code a prefix value;
code a suffix value, wherein the combination of the suffix value and the prefix value identify the offset value.

56. The computer readable storage medium of claim 55, wherein
the one or more processors code the prefix value by decoding the prefix value and code the suffix value by decoding the suffix value.

57. The computer readable storage medium of claim 55, wherein
the one or more processors code the prefix value by generating the prefix value for inclusion in an encoded video bitstream and code the suffix value by generating the suffix value for inclusion in the encoded video bitstream.
